(19) United States
(12) Patent Application Publication
(10) Pub. No.: US 2022/0167566 A1
(43) Pub. Date: Jun. 2, 2022

(54) Greenhouse

(71) Applicant: Van der Hoeven Horticultural Projects B.V., Den Hoorn (NL)

(72) Inventors: Martinus Adrianus Wilhelmus Steentjes, Den Hoorn (NL); Vincent Martijn Kickert, Den Haag (NL)

(21) Appl. No.: 17/537,682

(22) Filed: Nov. 30, 2021

(30) Foreign Application Priority Data
Dec. 1, 2020 (NL) 2027017

(51) Int. Cl. A01G 9/24

(52) U.S. Cl. CPC A01G 9/246

(57) ABSTRACT

A greenhouse having a roof, a floor, two end walls, and two side wall. Along one of the end or side walls an elongated mixing space is present next to an elongated space for conditioned air. The mixing space is fluidly connected to the exterior of the greenhouse and fluidly connected to a growing space by means of one or more openings. The mixing space and the space for conditioned air are fluidly connected via one or more water pads and via a parallel bypass flow path. The growing space comprises a multitude of parallel ventilation conduits, wherein each conduit has an air inlet that is fluidly connected to the space for conditioned air.

### BACKGROUND

### Field of the Invention

The invention is generally directed to a greenhouse wherein an elongated space is present along one of the walls of the greenhouse for conditioned ambient and/or greenhouse recirculating air. The elongated space is separated from a growing space of the greenhouse. The growing space comprises a multitude of parallel ventilation conduits that are fluidly connected to the elongated space.

### Related Art

A greenhouse design that is well known is generally referred to as semi-closed greenhouses. One of the first greenhouses build according to this principle is the semi-closed greenhouse build at Van der Lans, Rilland, The Netherlands in 2005. The elongated space of this greenhouse runs at the lower end and along the gable end wall. This space is provided with closable windows to allow ambient air to enter this space and closable valves at the upper end of this elongated space to allow air from the growing section to enter this space. The elongated space itself is provided with indirect heat exchangers to heat or cool the temperature of the ambient air, recirculating air, or their mixtures.

WO2008/002686 describes a greenhouse provided with a space at the end gable wall in which ambient air and/or greenhouse recirculating air is collected and distributed in a growing section via a multitude of parallel ventilation tubes. A heat exchanger may be present at the inlet of the fans that draw in air into the ventilation tubes to either cool or heat this air. According to this publication the interior of the greenhouse may be reduced in temperature by drawing in ambient air via a pad cooling system arranged at the inlet for ambient air in the end wall and distributing this air via the ventilation tubes.

JP20156133 describes a greenhouse with a space at the end gable wall in which ambient air and/or greenhouse recirculating air is collected and distributed in a growing section via a multitude of parallel ventilation tubes. Ambient air, optionally in admixture with greenhouse recirculating air, passes a water pad before being distributed in the growing section. Optionally, greenhouse recirculating air may be mixed with the air that has passed the water pad before being distributed in the growing section.

Controlling the climate in a greenhouse by using ambient air and greenhouse recirculating air has been known for many years and an example is described in U.S. Pat. No. 3,404,618, which published in 1968. In this publication ventilation tubes are described that distribute ambient air, recirculating greenhouse air, or combinations into the growing area of a greenhouse. At night time only greenhouse air is recirculated and heated by direct firing. During daytime, when the air within the greenhouse rises because of the sun radiation, colder ambient air is drawn in to be combined with the recirculating greenhouse air. By introducing only ambient air while not recirculating air a maximum cooling is achieved. Additional cooling may be achieved by drawing in air through water-cooled pads.

WO2017/176114 describes a greenhouse where ambient air is cooled by first contacting air with liquid water to obtain a cooled and saturated air flow in an evaporative pad. This air flow is subsequently contacted with an aqueous 1,2-propanediol solution to dry the air. The dry air is contacted with water to obtain cooled air. This cooled air is distributed to a growing section via ventilation tubes. A problem of this process is its complexity.

A disadvantage of the prior art processes that use water pads is that air may be obtained having up to a 100% saturation of water. Such a high saturation is preferably avoided because it may cause wear of the ventilators that are used to draw in air into the ventilation tubes. This may be mitigated by subsequently heating this air flow. However, when cool air is required to cool down the air in the greenhouse growing space, a subsequent heating of the air is not preferred.

### SUMMARY OF THE INVENTION

The object of the present invention is to provide a greenhouse that does not have the disadvantages of the prior art greenhouses. This is achieved by the following greenhouse.

A greenhouse having a roof, a floor, two end walls and two side walls and wherein along one of the end walls or side walls an elongated mixing space is present positioned next to an elongated space for conditioned air and wherein the mixing space and the space for conditioned air is separated from a growing space as present within the greenhouse,

wherein the mixing space is fluidly connected to the exterior of the greenhouse by means of one or more openings for ambient air and fluidly connected to the growing spaces by means of one or more openings,

wherein the mixing space and the space for conditioned air are fluidly connected via one or more water pads and via a parallel air flow path wherein the water pads are positioned parallel to the parallel air flow path, and

wherein the growing space comprises a multitude of parallel ventilation conduits and wherein each conduit has an air inlet provided with a ventilator and which air inlet is fluidly connected to the space for conditioned air.

Applicants found that the presently described greenhouse is better able to condition the air as it is distributed by the ventilation conduits. In addition to being able to mix ambient air and air from the growing section to obtain feed air, one has the added option to further treat this feed air to a conditioned air having a desired humidity. Air as formed in the water pads having a too high humidity may now be mixed with air from the parallel air flow path. This air bypasses the water pads. In this way the excessive humidity may be reduced by the sensible heat of, for example, warm recycle air from the growing section. This results in a more energy efficient climate control. The design of the greenhouse further allows for a careful control of the humidity of the air as it is distributed via the ventilation conduits.

An embodiment of the invention is therefore also directed to the following process. The process controls the temperature and/or humidity in a greenhouse comprising a growing space and a separate mixing space comprising the following steps:

(a) collecting ambient air and air from the growing space in the separate mixing space to obtain feed air,

(b) directly contacting part of the feed air with liquid water to adiabatically cool the mixed air to obtain a humid air and wherein another part of the feed air is not contacted directly with liquid water to obtain bypass air, and

(c) mixing the humid air and the heated air to obtain a conditioned air and discharging the conditioned air to the growing space.

The greenhouse may have a saddle roof or an arched roof. The saddle or arched shape roof runs parallel to the side walls from one end wall to the other end wall. In other words, the ridge beams of these roof types run parallel to the side walls. The walls and roof may comprise glass panels or plastic foils. Preferably the greenhouse has a rectangular shape or floor plan, wherein the end walls, also referred to as end gable walls, are connected to the side walls perpendicularly. In the context of two or more greenhouses according to embodiments of the invention, the two or more greenhouses may be positioned adjacent to each other where a side wall or end wall is shared.

Along one of the end or side walls an elongated mixing space is present and positioned next to an elongated space for conditioned air. The mixing space may be positioned next to and/or above the space for conditioned air. The mixing space is suitably at least present in the upper half of the greenhouse. The mixing space is suitably separated from the growing space an inner wall, which may be a transparent wall. In this inner wall the one or more openings are present which fluidly connect the growing space with the mixing space. These openings are preferably at a higher elevation than the maximum height of the cultivation growing in the growing space. This allows for a substantially horizontal flow of air above the cultivation towards these one or more openings in the inner wall. The openings are semi-closable. Semi-closable is herein meant that the opening cannot be 100% closed, which result in that some air will always flow from the growing section to the mixing space. Such a semi-closable opening may be a closable curtain made of a gas permeable material or it may be a flap which due to a programmed restriction in the control software or due to a mechanical obstruction cannot fully close the opening. The semi-closed opening may be designed such that at least 1 volume part of air from the growing space enters the mixing space per 20 volume parts of ambient air entering the mixing space.

The openings for ambient air are semi-closable. As noted above, semi-closable is herein meant that the opening cannot be 100% closed such that some ambient air will always flow into the mixing space. Such a semi-closable opening may be a closable curtain made of a gas permeable material or it may be a flap which due to a programmed restriction in the control software or due to a mechanical obstruction cannot fully close the opening. The semi-closed opening may be designed such that at least one volume part of ambient air enters the mixing space per 20 volume parts of air entering the mixing space from the growing section.

The parallel air flow path may be formed by an opening or openings between the mixing space and the space for conditioned air. This opening does not comprise a water pad. At the upstream end, or said otherwise at the inlet, of the conduits a ventilator is suitably present. By action of this ventilator the pressure in the space for conditioned air will be lower than the pressure in the mixing space resulting in a positive air flow from the mixing space via the water pads and via the parallel air flow path to the space for conditioned air. The ratio of air that flows via water pads and the parallel air flow path may thus be influenced by the size of these opening or openings. The size of the openings may be influenced by means of levers. Preferably this ratio is influenced by air displacement means as present in the bypass air flow path. By controlling these air displacement means, suitably ventilators, the flow of air that flows via the parallel air flow path may be controlled.

Further it is preferred that the parallel air flow path comprises one or more heating units. These heating units may be indirect heat exchange units. For example a shell-tube heat exchange unit wherein a heating fluid, for example water, flows via tubes and the air flows at the so-called shell side of the heat exchanger. The flow and/or temperature of the heating fluid are preferably controllable. In this way an optimal volume of bypass air having an optimal temperature may be obtained to obtain a desired volume of conditioned air having a desired temperature and humidity.

The mixing space is fluidly connected to the exterior of the greenhouse by means of openings for ambient air. These openings may be present in the end wall or side walls along which the elongated mixing space is present. In such an embodiment the respective end wall or side wall defines the mixing space. The location of these one or more openings in the end wall or side wall may be at the lower end of the end wall or side wall and more preferably at the same elevation as the one or more openings in the above referred to inner wall or even above the elevation of the one or more openings in the above referred to inner wall. Even more preferred, the openings to the exterior of the greenhouse for ambient air of the mixing space are openings in the roof. This is advantageous because this allows one to position two neighbouring greenhouses according to embodiments of the invention close together. In a most extreme embodiment, the end wall or side wall along which the elongated mixing space of each greenhouse is positioned may even be shared between both greenhouses. This allows one to combine multiple greenhouses provided with a mixing space according to embodiments of this invention into a multi-compartmented greenhouse having multiple non fluidly connected mixing spaces.

The growing space is preferably provided with openings to discharge air from within the growing section to the exterior of the greenhouse. The need for such openings may be understood when one realises that ambient air is drawn into the growing space via the multitude of parallel ventilation conduits. Without these openings a pressure build up would result which would in turn damage the glass or plastic covered greenhouse walls and roof. These openings may be closable windows in a preferred saddle roof or arched roof. Alternatively these openings may be present in the beam ridge of a preferred saddle roof as described in applicants' patent application WO2019/125169.

The growing space comprises a multitude of parallel ventilation conduits. The ventilation conduits suitably are positioned just above the floor of the greenhouse in the growing space. The conduits are suitably positioned below a cultivation gutter in which the vegetation grows. The conduits are provided with air outlet openings along their length. The conduits may have any design, for example having a circular or semi-circular cross-section. Preferably the conduits are tubes. Such ventilation tubes are well known and have been used in numerous greenhouses such as the afore mentioned semi-closed greenhouse build at Van der Lans, Rilland, The Netherlands. The ventilation tubes may be comprised of an inner tube to create an annular space of equal static pressure which enhances a uniform outflow of air via a row or rows of openings positioned along the length of the tube.

Alternatively the conduits may be combined with a cultivation gutter as described in applicants' patent application WO2019/185503.

The elongated mixing space is present along one of the end walls or side walls and positioned next to an elongated space for conditioned air. Preferably the mixing space is present along the entire end wall such that the mixing space is defined by the end wall and parts of the facing side walls et each end of the space or the mixing space is present along the entire side wall such that the mixing space is defined by the side wall and parts of the end walls et each end of the mixing space. The mixing space and the space for conditioned air are preferably each a single space. This is advantageous because a more uniform climate control may be achieved.

The upper end of the mixing space may be defined by an interior roof part. Preferably the upper end of the mixing space is defined by the roof, for example when the openings to the exterior of the greenhouse for ambient air of the mixing space are openings in the roof. The mixing space is further defined by the end wall or side wall depending along which wall the elongated mixing space is positioned. The end wall or side wall also includes any inner wall placed adjacent to an end wall or side wall. The mixing space is also defined by a substantial vertical partition wall spaced apart from the end wall or side wall and running substantially parallel to the end wall or side wall. The distance between the wall of the greenhouse and this partition wall may be from 1 to 5 meters and may span for example a single saddle roof in a situation wherein the mixing space runs along the side wall of a greenhouse provided with a saddle roof. The mixing space is further defined by the floor or a substantially horizontal elevated partition floor spaced apart from the floor. An embodiment wherein the lower end of the mixing space is the floor is advantageous because it is simple and requires less supporting structure for an elevated partition floor and pads as will be described in more detail below.

The advantage of having an elevated floor is that an emergency escape route can be provided in the greenhouse from the growing area to the space for conditioned air. In such an embodiment less apparatuses, like pads and heating units, will be positioned on the floor of the greenhouse thereby creating an emergency route for personnel from the growing section to the space for conditioned air, which route is free from obstacles. The space for conditioned air is thus suitably defined by the substantially horizontal and elevated partition floor, the end wall or side wall depending on how the mixing space is positioned along which wall, and a substantial vertical partition wall spaced apart from the end wall or side wall. This partition wall may be positioned in the same vertical plane as the partition wall of the mixing space or may be positioned in a different vertical plane. The elevated partition floor is suitably spaced apart from the floor for at least 2 meters thereby allowing enough head space for the emergency route. The vertical partition wall of the space for conditioned air may be provided with a number of emergency doors forming part of the emergency route from the growing space to the space for conditioned air.

The air inlet of the multitude of parallel ventilation conduits are fluidly connected to the vertical inner wall of the space for conditioned air by a ventilator.

The mixing space and the space for conditioned air are fluidly connected via one or more water pads. These pads, also referred to as so-called evaporating pads, are suitably vertically positioned wetted screens through which water flows from its upper end to its lower end and air passes the screen in a substantially horizontal flow direction. The vertical wetted screen has an inlet side for air fluidly connected to the mixing space and an outlet side for air fluidly connected to the space for conditioned air. The air directly contacts the water in the pad resulting in that part of the liquid water evaporates. This results in a temperature decrease of the air and an increase of gaseous water in the air. Such cooling is also referred to as adiabatic cooling.

The mixing space and the space for conditioned air are also fluidly connected via one or more indirect heating units. The pads are positioned parallel to the one or more indirect heating units resulting in that part of the air from the mixing space is cooled when passing the pad or pads and another part of the air is increased in temperature when passing the one or more indirect heating units.

The vertical wetted screen described above may be positioned on the floor or on the partition floor. The wetted screen preferably runs for more than 80% along of the length of the elongated mixing space. The wetted screen or a wall comprising the vertical screen will have an elongated upper end. To this upper end it is preferred to connect a roof part. This roof part is also connected to the vertical partition of the mixing space and comprises the one or more indirect heating units. The one or more heating units have an inlet side for air fluidly connected to the mixing space and an outlet side for air fluidly connected to the space for conditioned air. The roof part may be positioned under an angle or horizontally.

In step (a) of the process according to embodiments of this invention ambient air and air from the growing space are collected in a separate mixing space to obtain feed air. When a greenhouse is used, which has the earlier described semi-closable openings for ambient air and semi-closable openings for air from the growing space, then a situation exists where always ambient air and air from the growing space is collected in the mixing space. The volume of ambient air and air from the growing space is collected will depend on the area of the openings. By controlling this area it is possible to control the relative volumes and the absolute volumes of ambient air and air from the growing section which is collected mixing space. The absolute volume will suitably also be controlled by the under pressure created in the mixing space by air displacement means which move the air from this space to the growing section.

In step (b) part of the feed air is directly contacted with liquid water to adiabatically cool the mixed air to obtain a humid air. The air as obtained may have a relative humidity of above 85% and typically between 90 and 95%.

In step (b) the temperature of the feed air which is not contacted directly with liquid water may suitably be increased in temperature before performing step (c) as also described earlier. The desired temperature increase may for example depend on the temperature and humidity of the feed air, the volume of bypass air, the volume of air which is adiabatically cooled and the desired temperature and humidity of the conditioned air suited for conditioning the air in the growing section. For example when a large volume of feed air flows via the parallel air flow path less or even no heating may be necessary, while when low volumes are used more heating may be necessary. The relative humidity of the conditioned air may vary and may for example depend on the type of cultivation in the growing section, the age of the cultivation, and the moment during the day.

In step (c) the humid air and the heated air are mixed to obtain the conditioned air. The conditioned air is subsequently discharged to the growing space. Preferably this discharge is via a multitude of parallel ventilation conduits as described above.

The separate mixing space is suitably a continuous space running along the end wall or side wall of a rectangular greenhouse. More preferably this space runs along the entire end wall or side wall or at least along 80% of its length. The rectangular greenhouse suitably has a roof, a floor, two end walls and two side walls, wherein the mixing space is defined by part of the roof of the greenhouse, an end wall or a side wall, and a vertical partition wall spaced apart from the end wall or side wall and running substantially parallel to the end wall or side wall. The mixing space is further defined by the floor or a substantially horizontal and elevated partition floor spaced apart from the floor. The ambient air enters the mixing space via one or more openings in the end wall or side wall and/or preferably in the roof. The air from the growing space enters the mixing space via one or more openings in the partition wall.

The greenhouse suitably comprises a space for conditioned air below the substantially horizontal and elevated partition floor. In step (c) the conditioned air is suitably discharged to the growing space via a multitude of parallel ventilation conduits in the growing space which ventilation conduits have an inlet for conditioned air that is fluidly connected to this space for conditioned air.

### BRIEF DESCRIPTION OF THE DRAWINGS

Embodiments of the invention will be illustrated by the following figures.

FIG. 1 shows a cross-sectional view of a greenhouse according to an embodiment of the invention.

FIG. 2 shows an embodiment of the greenhouse where a mixing space is present along an entire end wall.

FIG. 3 shows a variant of the greenhouse of FIG. 1.

FIG. 4 shows a variant of the greenhouse of FIG. 3.

FIG. 5 shows a three-dimensional view of the greenhouse of FIG. 3.

FIG. 6 shows a greenhouse according to an embodiment of the invention.

FIG. 7 shows a greenhouse according to an embodiment of the invention.

FIG. 8 shows a cross-sectional view of greenhouse shown in FIG. 7.

### DETAILED DESCRIPTION

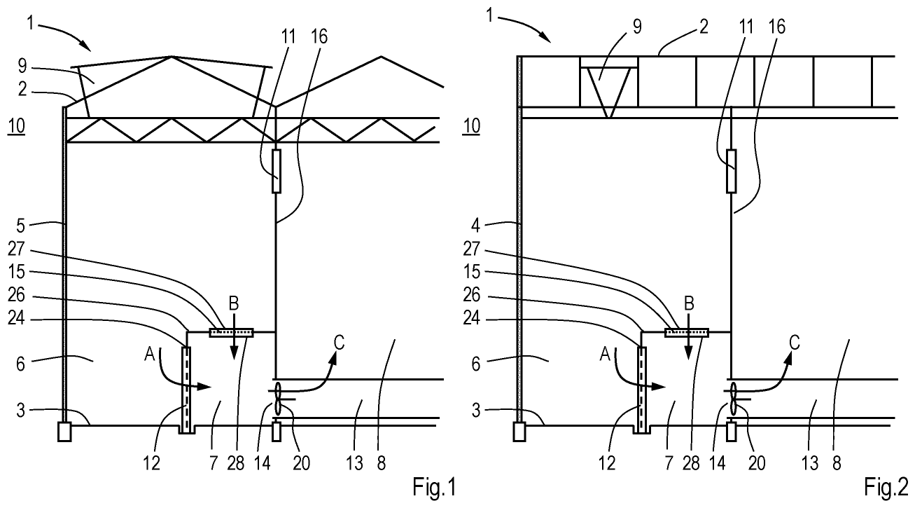

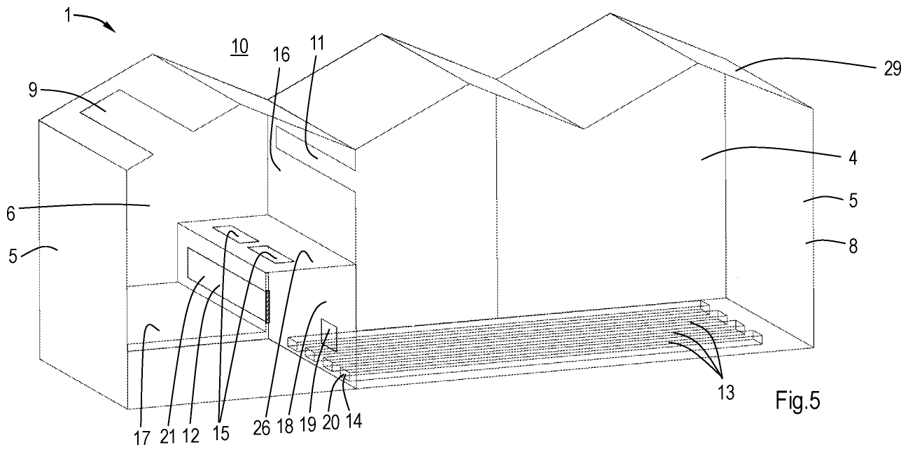

FIG. 1 shows a cross-sectional view of a greenhouse (1) having a saddle roof (2) and a floor (3). An elongated mixing space (6) is present along the entire side wall (5). The mixing space (6) is fluidly connected to the exterior (10) of the greenhouse by means of closable openings (9) for ambient air as present in the saddle roof (2). These openings (9) may be a single elongated opening running substantially along the entire length of the elongated mixing space (6) and saddle roof (2) as shown in FIG. 5. An elongated space (7) for conditioned air is shown positioned at the lower end of a partition wall (16). At the upper end part of this partition wall (16) one or more closable openings (11) are shown which openings (11) allow air to flow from a growing space (8). The mixing space (6) and the space (7) for conditioned air is separated from a growing space (8). The mixing space (6) and the space (7) for conditioned air are fluidly connected via one or more vertical screens (12) as the water pads and via one or more indirect heating units (15) as present in a parallel air flow path (B). The air from the mixing space (6) can flow to the space for conditioned air (7) via two parallel flow paths (A) and (B) as shown. The humid air flowing in air flow path (A) and the heated air in parallel air flow path (B) are mixed in the space (7) and the resulting conditioned air is distributed in the growing section (8) via a multitude of parallel ventilation conduits (13) as schematically represented by arrow C. Conditioned air enters the ventilation conduit at an inlet (14). At this inlet (14) a ventilator (20) is present.

The mixing space (6) of FIG. 1 is bounded by part of the roof (2), the side wall (5), part of the floor (3), partition wall (16) and part of two facing end walls (4) (as shown in FIG. 5). A horizontal roof part (26) is connected to the upper end (24) of the vertical wetted screen (12). The roof part (26) is connected at its other elongated end to the partition wall (16). The roof part (26) is comprised of the one or more indirect heating units (15) having an inlet side for air (27) fluidly connected to the mixing space (6) and an outlet side for air (28) fluidly connected to the space (7) for conditioned air.

FIG. 2 shows an embodiment of the greenhouse where the mixing space (6) is present along the entire end wall (4) comparable to the greenhouse of WO2008/002686. The other references have the same meaning as in FIG. 1 except for closable windows (9). These windows (9) in FIG. 2 will be separate windows present in the row of saddle roofs (2).

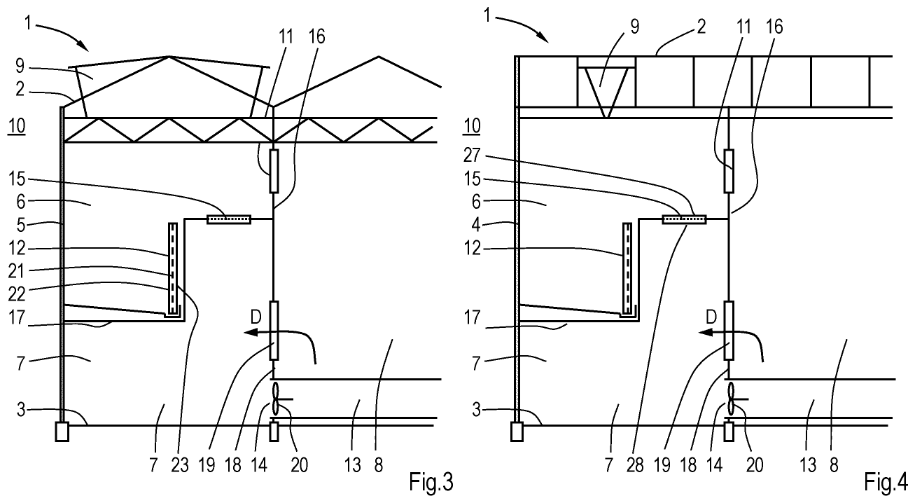

FIG. 3 is a variant of the greenhouse of FIG. 1. The difference is that the mixing space (6) is defined by the roof (2), a side wall (5), a substantial vertical partition wall (16) spaced apart from the side wall (5) and running substantially parallel to the side wall (5) and a substantially horizontal elevated partition floor (17) spaced apart from the floor (3) by at least 2 meters. The space (7) for conditioned air is defined by the substantially horizontal and elevated partition floor (17), the side wall (5) and a substantial vertical partition wall (18) spaced apart from the side wall (5). The vertical partition wall (18) is provided with a number of emergency doors (19) as part of an emergency escape route indicated by arrow D from the growing area to the space (7) for conditioned air. Door (19) may run all the way to the floor for easy access. Because the screens (12) and heating units (15) are positioned more elevated a free from obstacles emergency route for personnel from the growing section to the space for conditioned air is so provided. The upper side of partition floor (17) is slightly tilted such that any condensed water will flow towards the lower end of the screens (12) where it may be collected in a gutter to be discharged with the water running through the screens.

FIG. 4 is a variant of the greenhouse of FIG. 3 except that the mixing space (6) runs along the end wall (4).

FIG. 5 is a three-dimensional view of the greenhouse of FIG. 3. The dimensions are not entirely at scale. For example the width of a single saddle roof part, i.e., the width of the mixing space (6) may be about 4.5 m while the length of a single ventilation conduit (13) may be up to 110 meters as present below 25 saddle roof parts (29). The closable opening (9) and the closable opening (11) may run along the entire length of the side wall (5). Each passage between neighbouring ventilation conduits (13) may be provided with an emergency door (19). In this way workers as present in these passages have access to an emergency door.

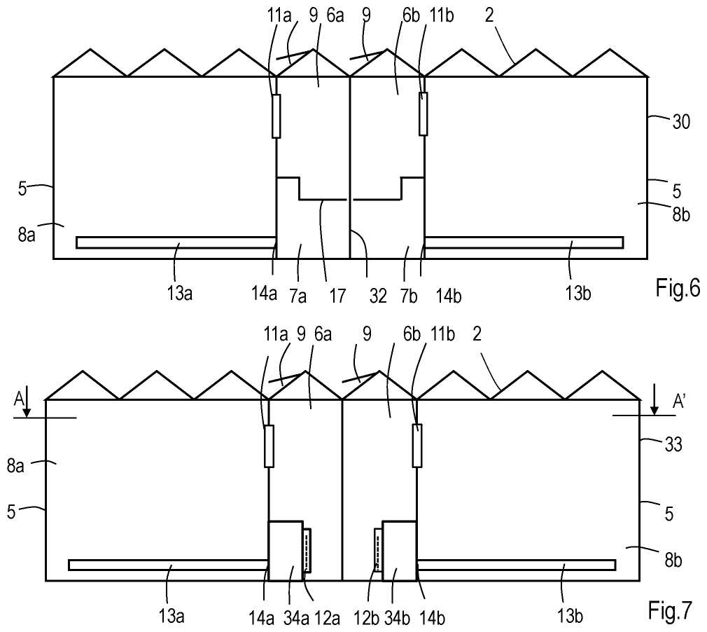

FIG. 6 shows a greenhouse (30) having a roof (2), a floor (3), two end walls (4) and two side walls (5), and a first and a second elongated mixing space (6a, 6b) which first and second elongated mixing space (6a,6b) separates a first and a second growing space (8a, 8b) as present within the greenhouse (30). First and second elongated mixing spaces (6a,6b) run parallel from end wall (4) to the opposite end wall (4) and suitably share a common wall (32) as shown. The first elongated mixing space (6a) is fluidly connected to the exterior (10) of the greenhouse by means of openings (9a) for ambient air in the roof (2) and fluidly connected to the first growing space by means of one or more openings (11a). The second elongated mixing space (6b) is fluidly connected to the exterior (10) of the greenhouse by means of openings (9b) for ambient air in the roof (2) and fluidly connected to the second growing space by means of one or more openings (11b). The first growing space (8a) comprises a multitude of parallel ventilation conduits (13a) and wherein each conduit (13a) has an air inlet (14a) that is fluidly connected to the first mixing space (6a).The second growing space (8b) comprises a multitude of parallel ventilation conduits (13b), wherein each conduit (13b) has an air inlet (14b) that is fluidly connected to the first mixing space (6b). The elongated mixing spaces (6a,6b) have the configuration of FIG. 3 and for clarity reasons only the partition floor (17) and the space (7) for conditioned air is shown. In FIG. 6 the first and second elongated mixing spaces (6a,6b) share a common wall (32) as shown and as preferred. Alternatively between the two mixings spaces of the multi-compartmented greenhouse (30) a small corridor for maintenance and accessing of the mixing spaces (6a,6b) and/or the space (7) for conditioned air may be present.

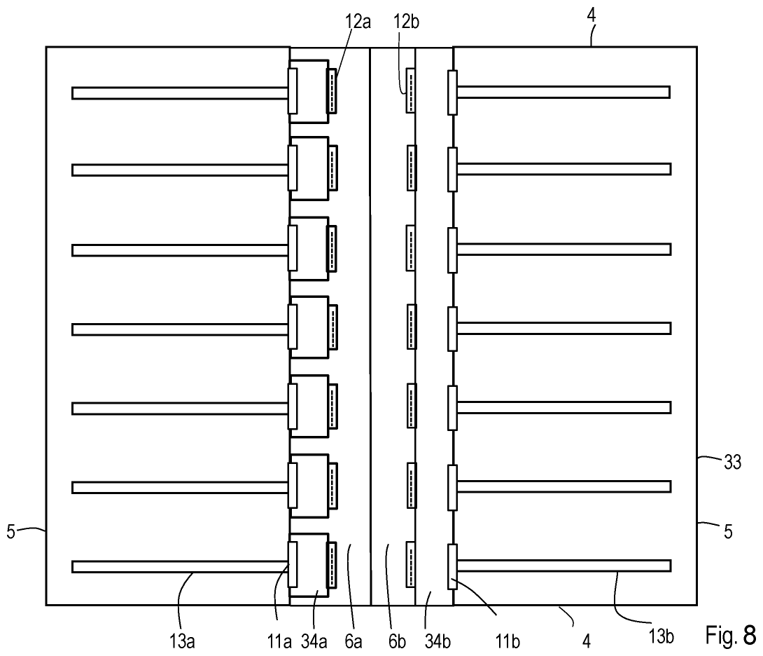

FIG. 7 shows a greenhouse (33) which is similar to greenhouse (30) of FIG. 6 except in that no parallel air flow path (B) is present. In this greenhouse all the ambient air and air from growing spaces (8a,8b) flows via one or more vertical screens (12a,12b) functioning as water pads. The space downstream these vertical screens (12a,12b) may be one continuous space for every first and second elongated mixing space (6a,6b) and/or may be separate spaces as illustrated in FIG. 8.

FIG. 8 shows a cross-sectional view AA′ of FIG. 7. For first elongated mixing space (6a) the space downstream vertical screen (12a) are separate spaces (34a) per conduit (13a). For second elongated mixing space (6b) the space downstream vertical screen (12b) is one continuous space (34b) fluidly connected to all conduits (13b).

An advantage of a combined greenhouse according to FIG. 6, 7, or 8 is that unit operations can be closer together as compared to when two separately spaced greenhouses would be used. Further less area is required for the same area of growing space for the combined greenhouse because no space is required at the sides or ends for intake of ambient air.

### EXAMPLE 1

A greenhouse according to FIGS. 3 and 5 is simulated wherein ambient air (10) of 35 C and a relative humidity of 40% is used. The air in the growing section (8) has a temperature of 32° C. and has a relative humidity (RH) of 85%. Further properties are listed in Table 1. The control object in this example is to reduce the temperature of the air in the growing section (8) and not increasing the relative humidity by obtaining conditioned air in space (7) and providing this conditioned air via the ventilating conduits (13) into the growing section.

The conditioned air in (7) is obtained by first mixing 95 volume parts of the ambient air (10) with 5 volume parts in mixing space (6) to obtain a feed air having a temperature of 34.8° C. and a relative humidity of 42.1%. Of this feed air 84 vol % is contacted with liquid water in the water pads (12) to obtain humid air having a temperature of 25.4° C. and a relative humidity of 90.2%. The remaining 16 vol. % of the feed air bypasses or otherwise circumvents the water pads (12) via parallel air flow path (B) (as in FIG. 1) and is mixed with the humid air to obtain conditioned air having a temperature of 27° C. and a relative humidity of 79.5%. In this example the air in parallel air flow path (B) is not heated. The conditioned air has a lower temperature than the air in the growing section and has a lower relative humidity and is thus suited to reduce the temperature in the growing section (8) when supplied to said growing section via ventilation conduits (13) and decreasing the humidity in the growing section (8).

### EXAMPLE 2

Example 1 is repeated except that the air in parallel air flow path (B) is heated increasing its enthalpy by about 0.1 kJ/kg. The temperature of the resulting conditioned air in space (7) is 27.1° C. and the relative humidity (RH) is 78.9%. As in Example 1 the conditioned air has a lower temperature than the air in the growing section and has an even lower relative humidity and is thus suited to reduce the temperature in the growing section (8) when supplied to said growing section via ventilation conduits (13) and decreasing the humidity in the growing section (8).

### Comparative Experiment

This calculated experiment will show how the same ambient air of examples 1 and 2 is used to cool the air in the growing section having the same starting conditions as in Examples 1 and 2 in a state-of-the-art greenhouse. In this example the ambient air is first reduced in temperature by direct contacting with liquid water in water pads to obtain a humid air having a temperature of 25.1° C. and a relative humidity (RH) of 89.8%. In order to reduce the humidity to a value below the humidity in the growing section this humid air is heated to 27.1° C. (equal to Example 2) and having a relative humidity of 80%. The amount of energy required for this heating step is about 2 kJ/kg.

Thus in the prior art greenhouse significantly more energy is required to obtain suitable air for supplying to the growing section in order to cool the air in the growing section of the prior art greenhouse. Further the humidity of this air is even higher than in Example 2. This comparison shows that the greenhouse according to an embodiment of the invention and the process provides a more energy efficient process and lower relative humidity air for conditioning the interior of the growing space of a greenhouse.

TABLE 1

| | | | Comparative |
|---|---|---|---|
| | Example 1 | Example 2 | experiment |
| Ambient air (° C.) | 35.0 | 35.0 | 35.0 |
| Ambient air RH (%) | 40 | 40 | 40 |
| Enthalpy ambient air (kJ/kg) | 71.44 | 71.44 | 71.44 |
| Starting air temperature in | 32 | 32 | 32 |
| growing section (° C.) | | | |
| Starting RH in growing | 85 | 85 | 85 |
| section (%) | | | |
| Starting enthalpy in growing | 98.34 | 98.34 | 98.34 |
| section (kJ/kg) | | | |
| Temperature of conditioned | 27 | 27.1 | 27.1 |
| air as feed for ventilating | | | |
| conduits (° C.) | | | |
| RH of conditioned air as feed | 79.5 | 78.9 | 80 |
| for ventilating conduits (%) | | | |
| Enthalpy of conditioned air | 72.74 | 72.86 | 73.49 |
| as feed for ventilating | | | |
| conduits (kJ/kg) | | | |

1. A greenhouse comprising:
a roof;
a floor;
two end walls; and
two side walls,
wherein along one of the end walls or side walls an elongated mixing space is positioned next to an elongated space for conditioned air,
wherein the mixing space and the space for conditioned air are separated from a growing space that is present within the greenhouse,
wherein the mixing space is fluidly connected to the exterior of the greenhouse by openings for ambient air and fluidly connected to the growing space by one or more openings,
wherein the mixing space and the space for conditioned air are fluidly connected via one or more water pads and via a parallel air flow path,
wherein the water pads are positioned parallel to the parallel flow path,
wherein the growing space comprises multitude of parallel ventilation conduits, and
wherein each conduit has an air inlet provided with a ventilator and which air inlet is fluidly connected to the space for conditioned air.

2. A greenhouse according to claim 1, wherein the parallel air flow path comprises one or more indirect heating units.

3. A greenhouse according to claim 1, wherein the parallel air flow path is provided with air displacement means.

4. A greenhouse according to claim 1, wherein the openings to the exterior of the greenhouse for ambient air are semi-closable openings designed such that at least one volume part of ambient air enters the mixing space per 20 volume parts of air entering the mixing space from the growing section.

5. A greenhouse according to claim 1, wherein the openings to the growing section of the greenhouse are semi-closable openings designed such that at least one volume part of air from the growing space enters the mixing space per 20 volume parts of ambient air entering the mixing space.

6. A greenhouse according to claim 1, wherein the openings to the exterior of the greenhouse for ambient air of the mixing space are openings in the roof.

7. A greenhouse according to claim 1, wherein the mixing space and the space for conditioned air are each a single space.

8. A greenhouse according to claim 1, wherein the mixing space is defined by the roof, an end wall or a side wall, a substantially vertical partition wall spaced apart from the end wall or side wall and that runs substantially parallel to the end wall or side wall, and the floor or a substantially horizontal elevated partition floor spaced apart from the floor.

9. A greenhouse according to claim 8, wherein the space for conditioned air is defined by the floor or substantially horizontal elevated partition floor, the end wall or side wall, and a substantially vertical partition wall spaced apart from the end wall or side wall.

10. A greenhouse according to claim 9, wherein the elevated partition floor is spaced apart from the floor for at least two meters and the vertical partition wall of the space for conditioned air is provided with a number of emergency doors.

11. A greenhouse according to claim 9, wherein the air inlets of the multitude of parallel ventilation conduits are fluidly connected to the vertical partition wall of the space for conditioned air by a ventilator.

12. A greenhouse according to claim 7, wherein the one or more water pads are comprised of a vertical wetted screen positioned on the floor or on the partition floor and run along more than 80% of the length of the elongated mixing space, and
wherein the vertical wetted screen has an inlet side for air fluidly connected to the mixing space and an outlet side for air fluidly connected to the space for conditioned air.

13. A greenhouse according to claim 12, wherein a horizontal roof part is connected to the upper end of the vertical wetted screen or to an upper end of a wall comprising the vertical wetted screen, the horizontal roof part extending to the vertical partition of the mixing space, and
wherein the roof part is comprised of the one or more indirect heating units having an inlet side for air fluidly connected to the mixing space and an outlet side for air fluidly connected to the space for conditioned air.

14. A process to control the temperature and/or humidity in a greenhouse comprising a growing space and a separate mixing space, the process comprising the following steps:
(a) collecting ambient air and air from the growing space in the separate mixing space to obtain feed air;
(b) directly contacting part of the feed air with liquid water to adiabatically cool the feed air to obtain a humid air, wherein another part of the feed air is not contacting directly with liquid water to obtain bypass air; and
(c) mixing the humid air and the bypass air to obtain a conditioned air, and discharging the conditioned air to the growing space.

15. A process according to claim 14, wherein the part of the feed air the is not contacted directly with liquid water is increased in temperature before performing step (c).

16. A process according to claim 14, wherein the separate mixing space is a continuous space running along an end wall or a side wall of the greenhouse, which is rectangular.

17. A process according to claim 16, wherein the rectangular greenhouse has a roof, a floor, two end walls, and two side walls,
wherein the mixing space is defined by part of the roof of the greenhouse, an end wall or a side wall, a vertical partition wall spaced apart from the end wall or side wall and running substantially parallel to the end wall or side wall, and the floor or a substantially horizontal and elevated partition floor spaced apart from the floor,
wherein the ambient air enters the mixing space via one or more openings in the end wall or side wall and/or in the roof, and
wherein the air from the growing space enters the mixing space via one or more openings in the partition wall.

18. A process according to claim 17, wherein the ambient air enters the mixing space via one or more openings in the roof.

19. A process according to claim 17, wherein the greenhouse comprises a space for conditioned air below the floor or substantially horizontal and elevated partition floor, and
wherein in step (c) the conditioned air is discharged to the growing space via a multitude of parallel ventilation conduits in the growing space, the ventilation conduits having an inlet for conditioned air that is fluidly connected to the space for conditioned air.

20. A greenhouse comprising:
a roof;
a floor;
two end walls;
two side walls; and
a first elongated mixing space and a second elongated mixing space that separate a first growing space and a second growing space that are present within the greenhouse,
wherein the first elongated mixing space is fluidly connected to the exterior of the greenhouse by openings for ambient air in the roof and fluidly connected to the first growing space by one or more openings,
wherein the second elongated mixing space is fluidly connected to the exterior of the greenhouse by openings for ambient air in the roof and fluidly connected to the second growing space by one or more openings,
wherein the first growing space comprises a multitude of parallel ventilation conduits, each conduit having an air inlet that is fluidly connected to the first mixing space, and
wherein the second growing space comprises a multitude of parallel ventilation conduits, each conduit having an air inlet that is fluidly connected to the first mixing space.

21. A greenhouse according to claim 20, wherein the first and second elongated mixing spaces are each positioned next to an elongated first and second space for conditioned air,
wherein the first and second elongated mixing spaces and the space for conditioned air are separated from the first and second growing spaces that are present within the greenhouse,
wherein the first and second elongated mixing spaces and the space for conditioned air are fluidly connected via one or more water pads and via a parallel air flow path,
wherein the water pads are positioned parallel to the parallel flow path,
wherein each of the multitude of parallel ventilation conduits of the first growing space have an inlet fluidly connected to the first space for conditioned air, and
wherein each of the multitude of parallel ventilation conduits of the second growing space have an inlet fluidly connected to the second space for conditioned air.

22. A greenhouse according to claim 20, wherein the first and second elongated mixing spaces run parallel from end wall to the opposite end wall.

23. A greenhouse according to claim 21, wherein the first and second elongated mixing spaces run parallel from end wall to the opposite end wall.

24. A greenhouse according to claim 22, wherein the first and second elongated mixing spaces share a common wall.
